(19) United States
(12) Patent Application Publication
(10) Pub. No.: US 2024/0075632 A1
(43) Pub. Date: Mar. 7, 2024

(54) ASSEMBLY, APPARATUS AND METHOD FOR MACHINING MECHANICAL PART

(71) Applicant: ABB Schweiz AG, Baden (CH)

(72) Inventors: Yong Chen, Shanghai (CN); Yin Tian, Shanghai (CN); Xiaojiong Yin, Shanghai (CN)

(21) Appl. No.: 18/262,460

(22) PCT Filed: Feb. 1, 2021
(86) PCT No.: PCT/CN2021/074684

§ 371 Date: Jul. 21, 2023

(51) Int. Cl. B25J 11/00; B23B 39/10; B23C 9/00

(52) U.S. Cl. CPC B25J 11/0055; B23B 39/10; B23C 9/00

(57) ABSTRACT

An assembly, an apparatus, and a method for machining a mechanical part. The assembly includes a parallel robot adapted to be mounted onto a platform under the mechanical part to be machined. The assembly includes a servo spindle mounted on the parallel robot and configured to drive a machining tool to rotate. The parallel robot is configured to drive the servo spindle to translate along the one or more axes with respect to the parallel robot. During the machining of the mechanical part, the parallel robot may drive the servo spindle to translate along the one or more axes under the mechanical part, such that the machining tool may cut out the required shapes and characteristics at a bottom side of the mechanical part.

### FIELD

Example embodiments of the present disclosure generally relate to the field of mechanical part machining, and more specifically, to an assembly, an apparatus and a method for machining a mechanical part.

### BACKGROUND

Milling is a conventional process for part machining. A traditional mode of the milling is to use a computerized numerical control (CNC) milling machine or machining center to process a mechanical part. During the milling, a blank of the mechanical part is first fixed onto the CNC milling machine or machining center. Then, a high-speed rotary milling cutter is used to cut out required shapes and characteristics on the blank.

Currently, the most general mode of the milling is to use the milling machining center. The milling machining center can achieve a high-accuracy machining, but meanwhile it brings a number of shortcomings. First, owning to a limited operating range of the milling machining center, it can only be used to process mechanical parts of small to medium size instead of those of large size, such as aluminum work pieces. Second, the mechanical parts having complex curved surfaces are not able to be easily processed unless the machining center having five axes is adopted, which, however, would result in a low processing efficiency. Third, a large scale machining center or even a gantry type machining center is often required to support the processing of the mechanical parts of larger size, which would cause the cost of the machining center to be relatively high. Fourth, as the machining center occupies a large area, it is difficult to cooperate with other automatic equipment to realize automatic production lines. Fifth, in the machining center, a dedicated and customized fixture tooling would be needed to process different mechanical parts. Thus, the flexibility of the machining center is unsatisfactory.

Another conventional mode of the milling is to use an industrial robot, such as a six-axis joint robot, to hold the milling cutter for cutting the mechanical part. However, since the six-axis joint robot includes several joints, the stiffness of the six-axis joint robot would be low if the axes of the six-axis joint robot moves or rotates during the milling. In this case, the accuracy of milling using the six-axis joint robot would be adversely affected.

Thus, there is a need for an improved solution for milling the mechanical part.

### SUMMARY

In view of the foregoing problems, example embodiments of the present disclosure propose an assembly, an apparatus and a method for machining a mechanical part to reduce process difficulty and cost of the part machining and to increase process efficiency, flexibility and stiffness of the part machining.

In a first aspect, example embodiments of the present disclosure provide an assembly for machining a mechanical part. The assembly comprises a parallel robot adapted to be mounted onto a platform under the mechanical part to be machined and comprising one or more axes; and a servo spindle mounted on the parallel robot and configured to drive a machining tool to rotate, wherein the parallel robot is configured to drive the servo spindle to translate along the one or more axes with respect to the parallel robot. With these embodiments, during the machining of the mechanical part, the parallel robot may drive the servo spindle to translate along the one or more axes under the mechanical part, such that the machining tool may cut out the required shapes and characteristics at a bottom side of the mechanical part. In this way, the mechanical part may be processed with higher flexibility and efficiency in the case that the machining accuracy meets the requirements.

In some embodiments, the parallel robot is a Cartesian robot configured to drive the servo spindle to translate along three axes normal to each other with respect to the parallel robot. With these embodiments, the parallel robot may drive the servo spindle to translate along one or more of the three axes, so as to cut out the required shapes and characteristics at the bottom side of the mechanical part.

In some embodiments, the assembly further comprises the machining tool held by the servo spindle and configured to rotate under driving of the servo spindle.

In some embodiments, the machining tool comprises a drilling tool or a milling tool. With these embodiments, the mechanical part may be milled or drilled with high flexibility and efficiency in the case that the machining accuracy meets the requirements.

In a second aspect, example embodiments of the present disclosure provide an apparatus for machining a mechanical part. The apparatus comprises a positioner configured to hold the mechanical part to be machined and adjust an orientation of the mechanical part; and an assembly according to the first aspect of the present disclosure. The assembly is arranged on a platform under the mechanical part to machine the mechanical part from a bottom side of the mechanical part. The apparatus according to the second aspect of the present disclosure may provide analogous advantages as the assembly according to the first aspect of the present disclosure. Moreover, with the positioner, an orientation of the mechanical part can be adjusted during the machining process.

In some embodiments, the apparatus further comprises a lubricating device configured to supply a lubricant to the machining tool. With these embodiments, the lubricant supplied by the lubricating device can not only protect the machining tool from being worn, but also prevent overheating of the machining tool.

In some embodiments, the apparatus further comprises a Human Machine Interface (HMI) configured to receive a user input for setting machining parameters of the mechanical part.

In a third aspect, example embodiments of the present disclosure provide a method for machining a mechanical part. The method comprises: receiving a user input for setting machining parameters of the mechanical part; and causing an assembly arranged on a platform under the mechanical part to machine the mechanical part based on the machining parameters, wherein the assembly comprises a parallel robot with one or more axes; a servo spindle mounted on the parallel robot, wherein the parallel robot is configured to drive the servo spindle to translate along the one or more axes with respect to the parallel robot; and a machining tool held by the servo spindle and configured to rotate under driving of the servo spindle to achieve the machining of the mechanical part. With these embodiments, the parallel robot and the servo spindle binding with the machining tool are used to machine the mechanical part based on the machining parameters. Such a solution is a kind of revolution which replaces the machining center and perfectly resolves the limitation of the six-axis industrial robot independently.

In some embodiments, the machining parameters comprise a position, a lateral dimension and a depth of a hole to be formed on the mechanical part and a lead of the machining tool.

In some embodiments, causing the assembly to machine the mechanical part based on the machining parameters comprises: causing the assembly to machine the mechanical part in a spiral feeding manner based on the machining parameters. With these embodiments, the mechanical part may be machined precisely and reliably.

In some embodiments, the hole comprises a circular hole and the lateral dimension of the hole comprises a radius of the circular hole.

In some embodiments, the hole comprises a waist-shaped hole and the lateral dimension of the hole comprises a length and a radius of the waist-shaped hole.

In some embodiments, the parallel robot is a Cartesian robot configured to drive the servo spindle to translate along three axes normal to each other with respect to the parallel robot.

In some embodiments, the machining tool comprises a drilling tool or a milling tool.

In some embodiments, the mechanical part is held by a positioner configured adjust an orientation of the mechanical part.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure improperly.

FIG. 1 illustrates a perspective view of an apparatus for machining a mechanical part in accordance with an embodiment of the present disclosure;

FIG. 2 illustrates a schematic view of a positioner for fixing the mechanical part in accordance with an embodiment of the present disclosure;

FIG. 3 illustrates a block diagram of an apparatus for machining a mechanical part in accordance with an embodiment of the present disclosure;

FIG. 4 illustrates a method for machining a mechanical part in accordance with an embodiment of the present disclosure;

FIG. 5A illustrates a schematic view of a circular hole to be formed on the mechanical part;

FIG. 5B illustrates an example machining path of the circular hole as shown in FIG. 5A;

FIG. 6A illustrates a schematic view of a waist-shaped hole to be formed on the mechanical part; and

FIG. 6B illustrates an example machining path of the waist-shaped as shown in FIG. 6A.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the present disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to embodiments of the present disclosure, in order to break through the typical shortcomings of the machining center and the limitation of using the six-axis industrial robot independently, an assembly, an apparatus and a method for machining a mechanical part are provided to reduce process difficulty and cost of the part machining and to increase process efficiency, flexibility and stiffness of the part machining. The above idea may be implemented in various manners, as will be described in detail in the following paragraphs.

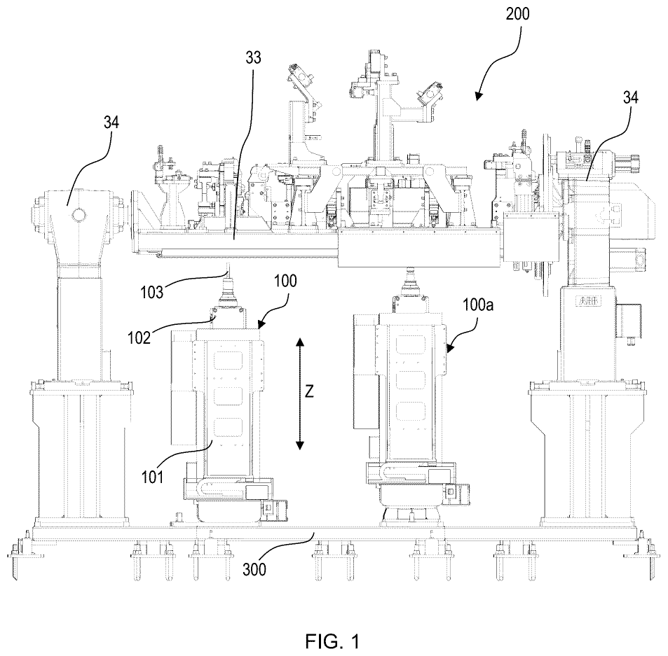

Hereinafter, the principles of the present disclosure will be described in detail with reference to FIGS. 1-6B.

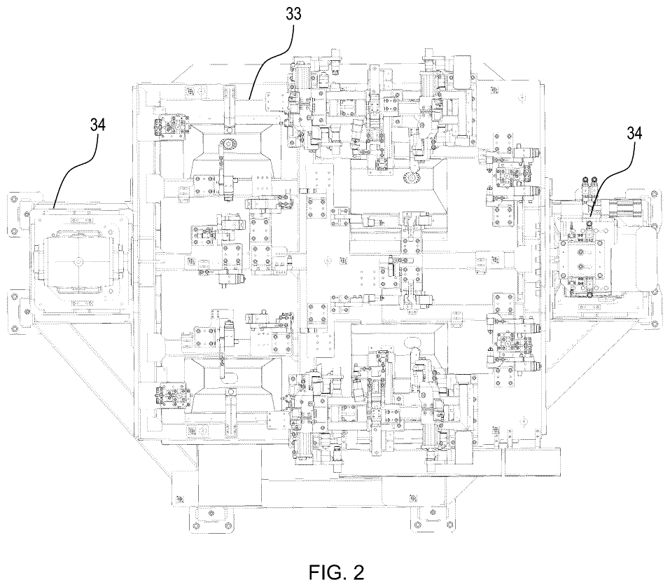

Referring to FIGS. 1 and 2 first, FIG. 1 illustrates a perspective view of an apparatus for machining a mechanical part in accordance with an embodiment of the present disclosure, and FIG. 2 illustrates a schematic view of a positioner for fixing the mechanical part in accordance with an embodiment of the present disclosure. As shown in FIGS. 1 and 2, the apparatus 200 described herein generally includes a positioner 34 and an assembly 100 for machining a mechanical part 33. The assembly 100 is arranged on a platform 300 under the mechanical part 33.

In some embodiments, as shown in FIGS. 1 and 2, the assembly 100 includes a parallel robot 101, a servo spindle 102, and a machining tool 103. The parallel robot 101 is mounted on the platform 300. The parallel robot 101 includes one or more axes so as to provide translational motion along the one or more axes. The servo spindle 102 is mounted on the parallel robot 101 and may be driven by the parallel robot 101 to translate along the one or more axes with respect to the parallel robot 101, i.e., with respect to the platform 300. The machining tool 103 is held by the servo spindle 102 and may rotate under driving of the servo spindle 102.

According to embodiments of the present disclosure, during the machining of the mechanical part 33, the parallel robot 101 may drive the servo spindle 102 to translate along the one or more axes under the mechanical part 33 held by the positioner 34 and the machining tool 103 may cut out the required shapes and characteristics at a bottom side of the mechanical part 33 under driving of the servo spindle 102. In this way, the mechanical part 33 may be processed with higher flexibility and efficiency.

Moreover, through using the apparatus 200 to machine circular and waist-shaped holes, it could fulfill different and even complex application requirements.

Moreover, the apparatus 200 is suitable for processing the mechanical part 33 having complex curved surfaces or different thicknesses, such as milling or drilling, due to using the parallel robot 101 to drive the servo spindle 102 binding with the machining tool 103. During the machining process, machining parameters of the mechanical part 33 can be controlled and adjusted automatically, such that the machining process has stronger flexibility.

Further, the apparatus 200 solves the problem regarding complexity and high cost of the customized devices in the traditional machining process of the mechanical part. Thus, it has stronger applicability, generality and economy which greatly decrease operating difficulty and cost.

In addition, the machining accuracy of the apparatus 200 may meet the requirements. For example, the machining accuracy is about −0.05 mm˜+0.05 mm, when the apparatus 200 is used to drill the circular and waist-shaped holes on the mechanical part 33.

In some embodiments, as shown in FIG. 1, the parallel robot 101 is a Cartesian robot configured to drive the servo spindle 102 to translate along three axes normal to each other with respect to the parallel robot 101. With these embodiments, the parallel robot 101 may drive the servo spindle 102 to translate along one or more of the three axes, so as to cut out the required shapes and characteristics at the bottom side of the mechanical part 33, such as the circular or waist-shaped holes.

In some embodiments, the parallel robot 101 is a single-axis robot configured to drive the servo spindle 102 to translate along a predetermined axis Z with respect to the parallel robot 101. With these embodiments, the parallel robot 101 may drive the servo spindle 102 to translate along the predetermined axis Z, so as to cut out the required shapes and characteristics on the mechanical part 33, such as the circular hole or a threaded hole.

In an embodiment, the parallel robot 101 may be a dedicated linear robot, such as a single-axis linear robot or a three-axis linear robot. In another embodiment, the parallel robot 101 may be obtained by modifying a conventional servo positioning device, for example by specially designing a control program of the servo positioning device. The scope of the present disclosure is not intended to be limited in this respect.

According to embodiments of the present disclosure, the apparatus 200 may be used to machine various shapes and characteristics on the mechanical part 33. The circular hole and the waist-shaped hole are only examples of the machined shapes and characteristics, without suggesting any limitation to the scope of the present disclosure. In other embodiments, the apparatus 200 may be used to drill or mill other holes or surfaces.

According to embodiments of the present disclosure, the platform 300 may be a dedicated work table, a bracket, or even the ground.

It is to be understood that the Cartesian robot and the single-axis robot are only example implementations of the parallel robot 101, without suggesting any limitation as to the scope of the present disclosure. In other embodiments, the parallel robot 101 may be of other types, such as including two axes normal to each other.

According to embodiments of the present disclosure, the servo spindle 102 may drive the machining tool 103 to rotate at a high speed so as to cut out the required shapes and characteristics at the bottom side of the mechanical part 33. The servo spindle 102 may be of various conventional structures or of a structure available in the future. The scope of the present disclosure is not intended to be limited in this respect.

In an embodiment, the machining tool 103 includes a milling tool so as to carry out a milling process on the mechanical part 33. In another embodiment, the machining tool 103 includes a drilling tool so as to carry out a drilling process on the mechanical part 33. It is to be understood that the milling tool and the drilling tool are only example implementations of the machining tool 103, without suggesting any limitation as to the scope of the present disclosure. In other embodiments, the machining tool 103 may be of other types.

It is to be understood that, in some embodiments, the assembly 100 may be manufactured or sold separately, and mounted onto the platform 300 when the machining process needs to be carried out on the mechanical part 33. It is also to be understood that the machining tool 103 may be not provided on the assembly 100 when the assembly 100 is manufactured or sold, and a user may install the corresponding machining tool 103 onto the servo spindle 102 according to the actual machining need.

In some embodiments, as shown in FIGS. 1 and 2, the positioner 34 may clamp the mechanical part 33 from both sides of the mechanical part 33. It is to be understood that in other embodiments, the positioner 34 may support the mechanical part 33 in other manners. The scope of the present disclosure is not intended to be limited in this respect.

The positioner 34 may adjust an orientation of the mechanical part 33 during the machining process. For example, in some embodiments, when the machining of the mechanical part 33 is finished, the positioner 34 may rotate the mechanical part 33, such that the other side of the mechanical part 33 could be processed by the machining tool 103. It is to be understood, in some embodiments, when the bottom side of the mechanical part 33 is being machined by the assembly 100, an upper side of the mechanical part 33 opposite to the bottom side may be machined by a joint robot simultaneously.

In some embodiments, as shown in FIG. 1, in addition to the assembly 100, the apparatus 200 may further include one or more additional assemblies 100a having the same structure as the assembly 100, so as to process the mechanical part 33 at other positions.

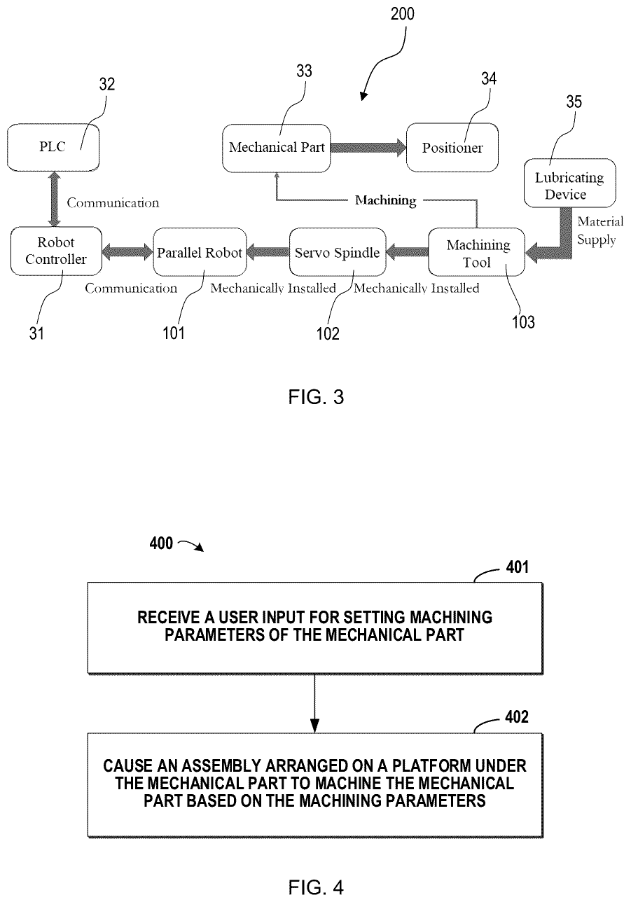

FIG. 3 illustrates a block diagram of an apparatus for machining a mechanical part in accordance with an embodiment of the present disclosure. As shown in FIG. 3, in addition to the positioner 34 and the assembly 100 as described above with reference to FIGS. 1 and 2, the apparatus 200 further includes some other devices/elements, as will be described in detail hereinafter.

In some embodiments, as shown in FIG. 3, the apparatus 200 further includes a lubricating device 35 configured to supply a lubricant to the machining tool 103. For example, the lubricating device 35 may include minimal quantity lubrication (MQL) device. During the machining process of the mechanical part 33, the lubricant may be sprayed onto the machining tool 103. With these embodiments, the lubricant supplied by the lubricating device 35 can not only protect the machining tool 103 from being worn, but also prevent overheating of the machining tool 103. Moreover, the supply of the lubricant may accelerate the machining speed of the mechanical part 33.

In some embodiments, as shown in FIG. 3, the apparatus 200 further includes a robot controller 31 in communication with the parallel robot 101. The movement of the axes of the parallel robot 101 is controlled by the robot controller 31. For example, the robot controller 31 may control the moving speed and the position of the axes of the parallel robot 101.

In some embodiments, as shown in FIG. 3, the apparatus 200 further includes a programmable logic controller (PLC) 32 in communication with the robot controller 31. The entire machining process is controlled by the PLC 32. Specifically, the operations of the parallel robot 101, the servo spindle 102, the lubricating device 35, and other electrical or electronic device are controlled by the PLC 32.

In some embodiments, the apparatus 200 further comprises a Human Machine Interface (HMI) configured to receive a user input for setting machining parameters of the mechanical part 33 and to implement one or more additional functions, such as real time monitoring of various components of the apparatus 200. With the HMI, the machining parameters of the mechanical part 33 may be set conveniently. Moreover, the HMI provides the user with a visualized and humanized window for achieving real time monitoring, warnings, and other functions.

FIG. 4 illustrates a method for machining a mechanical part in accordance with an embodiment of the present disclosure. The method 400 may be implemented by the apparatus 200 as described above with reference to FIGS. 1-3.

As shown in FIG. 4, at 401, a user input for setting machining parameters of the mechanical part 33 is received. In some embodiments, the user input may be received by the HMI of the apparatus 200. The HMI is easy to be manipulated and understood. With the HMI, the machining parameters of the mechanical part 33 may be set conveniently.

At 402, the assembly 100 arranged on the platform 300 is caused to machine the mechanical part 33 based on the machining parameters. The assembly 100 comprises a parallel robot 101 with one or more axes; a servo spindle 102 mounted on the parallel robot 101, wherein the parallel robot 101 is configured to drive the servo spindle 102 to translate along the one or more axes with respect to the parallel robot 101; and a machining tool 103 held by the servo spindle 102 and configured to rotate under driving of the servo spindle 102 to achieve the machining of the mechanical part 33.

In some embodiments, the method 400 may be used to drill a hole on the mechanical part 33. In this case, the machining parameters of the mechanical part 33 comprise a position, a lateral dimension and a depth of the hole to be formed on the mechanical part 33 and a lead of the machining tool 103. Through setting the machining parameters of the mechanical part 33, holes of different sizes and at different positions may be easily machined on the mechanical part 33.

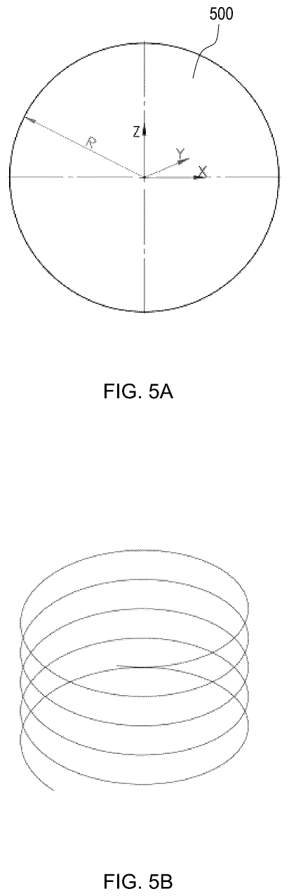

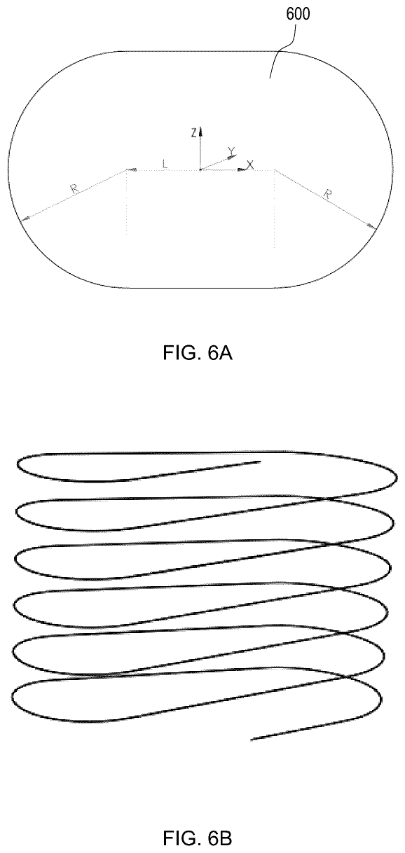

In some embodiments, the hole may be a circular hole 500 as shown in FIG. 5A. In some embodiments, the hole may be a waist-shaped hole 600 as shown in FIG. 6A. It is to be understood that in other embodiments, the method 400 may be used to drill or mill other types of holes or surfaces on the mechanical part 33.

When the hole is the circular hole 500 as shown in FIG. 5A, the lateral dimension of the hole comprises a radius R of the circular hole 500. When the hole is a waist-shaped hole 600 as shown in FIG. 6A, the lateral dimension of the hole comprises a length L of a central part of the waist-shaped hole 600 and a radius R of the end parts of the waist-shaped hole 600.

FIG. 5B illustrates an example machining path of the circular hole as shown in FIG. 5A, and FIG. 6B illustrates an example machining path of the waist-shaped as shown in FIG. 6A. In some embodiments, as shown in FIGS. 5B and 6B, the circular hole 500 and the waist-shaped hole 600 may be machined in spiral feeding manner. With these embodiments, the mechanical part 33 may be machined precisely and reliably.

In some embodiments, the parallel robot 101 is a Cartesian robot configured to drive the servo spindle 102 to translate along three axes normal to each other with respect to the parallel robot 101.

In some embodiments, the machining tool 103 comprises a drilling tool or a milling tool.

In some embodiments, the mechanical part 33 is held by a positioner 34 configured adjust an orientation of the mechanical part 33.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. An assembly for machining a mechanical part, comprising:
a parallel robot adapted to be mounted onto a platform under the mechanical part to be machined and comprising one or more axes; and
a servo spindle mounted on the parallel robot and configured to drive a machining tool to rotate,
wherein the parallel robot is configured to drive the servo spindle to translate along the one or more axes with respect to the parallel robot.

2. The assembly according to claim 1, wherein the parallel robot is a Cartesian robot configured to drive the servo spindle to translate along three axes normal to each other with respect to the parallel robot.

3. The assembly according to claim 1, further comprising the machining tool held by the servo spindle and configured to rotate under driving of the servo spindle.

4. The assembly according to claim 3, wherein the machining tool comprises a drilling tool or a milling tool.

5. An apparatus for machining a mechanical part, comprising:
a positioner configured to hold the mechanical part to be machined and adjust an orientation of the mechanical part; and
an assembly arranged on a platform under the mechanical part to machine the mechanical part from a bottom side of the mechanical part,
wherein the assembly comprises:
a parallel robot adapted to be mounted onto a platform under the mechanical part to be machined and comprising one or more axes; and
a servo spindle mounted on the parallel robot and configured to drive a machining tool to rotate,
wherein the parallel robot is configured to drive the servo spindle to translate along the one or more axes with respect to the parallel robot.

6. The apparatus according to claim 5, further comprising:
a lubricating device configured to supply a lubricant to the machining tool.

7. The apparatus according to claim 5, further comprising:
a Human Machine Interface configured to receive a user input for setting machining parameters of the mechanical part.

8. A method for machining a mechanical part, comprising:
receiving a user input for setting machining parameters of the mechanical part; and
causing an assembly arranged on a platform under the mechanical part to machine the mechanical part based on the machining parameters, wherein the assembly comprises a parallel robot with one or more axes; a servo spindle mounted on the parallel robot, wherein the parallel robot is configured to drive the servo spindle to translate along the one or more axes with respect to the parallel robot; and a machining tool held by the servo spindle and configured to rotate under driving of the servo spindle to achieve the machining of the mechanical part.

9. The method according to claim 8, wherein the machining parameters comprise a position, a lateral dimension and a depth of a hole to be formed on the mechanical part and a lead of the machining tool.

10. The method according to claim 9, wherein causing the assembly to machine the mechanical part based on the machining parameters comprises:
causing the assembly to machine the mechanical part in a spiral feeding manner based on the machining parameters.

11. The method according to claim 9, wherein the hole comprises a circular hole and the lateral dimension of the hole comprises a radius of the circular hole.

12. The method according to claim 9, wherein the hole comprises a waist-shaped hole and the lateral dimension of the hole comprises a length and a radius of the waist-shaped hole.

13. The method according to claim 8, wherein the parallel robot is a Cartesian robot configured to drive the servo spindle to translate along three axes normal to each other with respect to the parallel robot.

14. The method according to claim 8, wherein the machining tool comprises a drilling tool or a milling tool.

15. The method according to claim 8, wherein the mechanical part is held by a positioner configured adjust an orientation of the mechanical part.

16. The apparatus according to claim 5,
wherein the parallel robot is a Cartesian robot configured to drive the servo spindle to translate along three axes normal to each other with respect to the parallel robot.

17. The apparatus according to claim 16, further comprising:
a lubricating device configured to supply a lubricant to the machining tool.

18. The apparatus according to claim 16, further comprising:
a Human Machine Interface configured to receive a user input for setting machining parameters of the mechanical part.

19. The apparatus according to claim 5, wherein the assembly further comprises the machining tool held by the servo spindle and configured to rotate under driving of the servo spindle.

20. The apparatus according to claim 5, wherein the machining tool comprises a drilling tool or a milling tool.
